(19) United States
(12) Patent Application Publication
(10) Pub. No.: US 2021/0074207 A1
(43) Pub. Date: Mar. 11, 2021

(54) GRADUAL CHANGE OF PIXEL-RESOLUTION IN OLED DISPLAY

(71) Applicant: Google LLC, Mountain View, CA (US)

(72) Inventors: Sangmoo Choi, Palo Alto, CA (US); Sun-il Chang, San Jose, CA (US); Ion Bita, Santa Clara, CA (US)

(21) Appl. No.: 16/563,739

(22) Filed: Sep. 6, 2019

(51) Int. Cl. G09G 3/3225; H04M 1/02

(52) U.S. Cl. CPC G09G 3/3225; H04M 1/0266; H04N 5/2257; G09G 2340/0428; H04M 1/0264

(57) ABSTRACT

An apparatus is described that includes an organic light emitting diode (OLED) display and a sensor. The OLED display includes a first area having a first pixel density, a second area having a second pixel density, and a third area having a third pixel density. The second area is arranged between the first area and the third area. The first pixel density is lower than the second pixel density. The second pixel density is lower than the third pixel density. The sensor is arranged to receive electromagnetic radiation transmitted through the first area of the OLED display.

### TECHNICAL FIELD

The subject matter described herein relates to organic light emitting diode (OLED) displays, and more specifically to pixel arrangements in OLED displays.

### BACKGROUND

In general, organic light emitting diode (OLED) displays are emissive flat panel displays featuring an array of pixels, each of which includes at least one OLED. During operation, a pixel circuit delivers electric current to the OLED, causing it to emit light. Pixels in full color OLED displays often include multiple sub-pixels, each emitting light of a different color. The sub-pixels are sufficiently small and closely-spaced such that a viewer perceives the multi-colored emission to emanate from a single point having a color corresponding to the combined spectral emissions of the sub-pixels.

### SUMMARY

In some devices, such as smartphones, it is desirable to include front-facing sensors, i.e., sensors that face in the same direction as the device's display. Traditionally, such sensors (e.g., cameras, facial recognition sensors) have been housed in the display's bezel. However, it can be desirable to minimize the size of the display's bezel. In some cases, such as where the bezel is narrow, the front-facing sensors are positioned behind the display and detect light that is transmitted through the display.

In certain cases, the display can include a region with lower pixel density above the front-facing sensor. This can facilitate increased transmission of light through the display to the sensor, thereby improving the quality of any signal detected by the sensor. In such cases, the display can include adjacent areas having different pixel densities, and therefore different resolutions.

When an organic light emitting diode (OLED) display has two adjacent areas with significantly different resolutions of pixels in those areas, the image rendered on the OLED display can have an undesirably sharp contrast in image quality along the boundary of those two areas. For example, FIGS. 1A and 1B illustrate an OLED display 102 having a first area 104 with a pixel-resolution of 222 pixels per inch, and a second area 106 with a pixel-resolution of 444 pixels per inch. As the resolutions of 222 pixels per inch and 444 pixels per inch are significantly apart, the image rendered on the OLED display 102 has an undesirably sharp contrast in image quality along the boundary 108 of those two areas 104 and 106.

Organic light emitting diode (OLED) displays are described that have a gradual change of resolution of pixels. Such a resolution gradient can avoid an undesirable sharp contrast in image quality that occurs when there is a significantly large change in resolution of the pixels in adjacent areas.

In one aspect, an apparatus is described that includes an organic light emitting diode (OLED) display and a sensor. The OLED display includes a first area having a first pixel density, a second area having a second pixel density, and a third area having a third pixel density. The second area is arranged between the first area and the third area. The first pixel density is lower than the second pixel density. The second pixel density is lower than the third pixel density. The sensor is arranged to receive electromagnetic radiation transmitted through the first area of the OLED display.

In some variations, one or more of the following can be additionally implemented either individually or in any feasible combination. The OLED display further includes a fourth area between the second area and the third area. The fourth area has a pixel density between the second pixel density and the third pixel density. The apparatus further includes a display driver module programmed to display images in the second area at the second pixel density lower than a physical pixel density in the second area. The physical pixel density in the second area and a physical pixel density in the third area are the same. The physical pixel density in the third area and the third pixel density are the same.

Pixels in the first area are arranged in pixel clusters in a first pattern, and pixels in the second area are arranged in pixel clusters in a second pattern that is different from the first pattern. The first pattern is a quarter pattern. The second pattern is a diamond pattern or a mosaic pattern. The second area surrounds the first area. The third area surrounds the second area. The first area is located at an edge of the display. The first area is 10% or less of a total area of the OLED display. The third area is 80% or more of a total area of the OLED display. The first pixel density is 250 pixels per inch or less. The third pixel density is 400 pixels per inch or more. The sensor is a camera. The apparatus is a smartphone.

The implementations discussed herein are advantageous. For example, the gradual change in resolution of pixels in the OLED display avoids undesirably sharp contrasts in image quality, thereby making the brightness of the image substantially uniform. Such OLED displays can also facilitate operation of sensors placed behind the display by providing a low pixel density area through which light can propagate to the sensor.

The details of one or more implementations are set forth below. Other features and advantages of the subject matter will be apparent from the detailed description, the accompanying drawings, and the claims.

### BRIEF DESCRIPTION OF THE DRAWINGS

FIG. 1A and FIG. 1B illustrate an OLED display with undesirably sharp contrast in image quality when two adjacent areas of the OLED display have significantly differing pixel-resolutions.

FIG. 2 illustrates another OLED display where adjacent areas have gradually differing pixel-resolutions.

FIG. 3 illustrates multiple pixel-clusters within an OLED display.

FIGS. 4A-4I illustrates examples of pixel-clusters with corresponding sub-pixels.

FIG. 5 is a table that illustrates examples of various patterns in which the pixel-clusters can be arranged.

FIG. 6 illustrates the pixel-clusters in different areas of the OLED display.

Like reference symbols in the various drawings indicate like elements.

### DETAILED DESCRIPTION

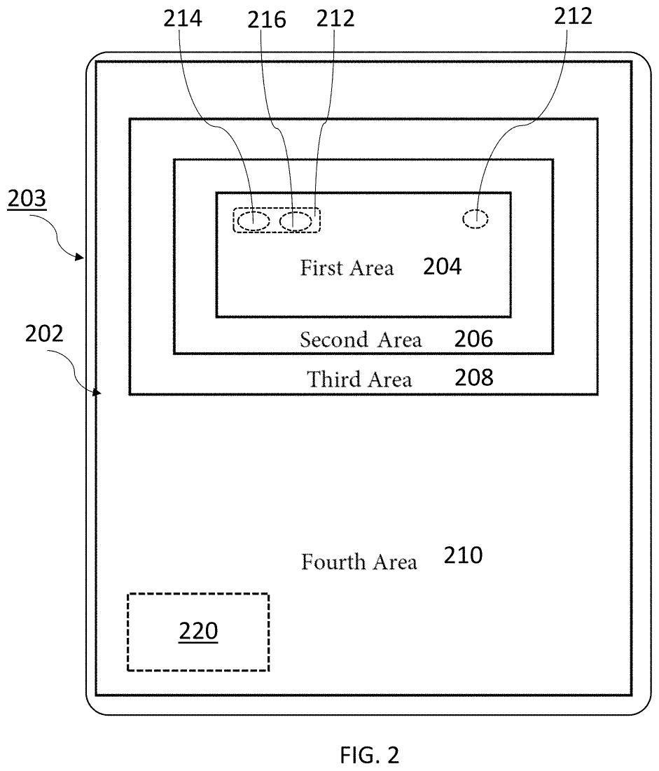

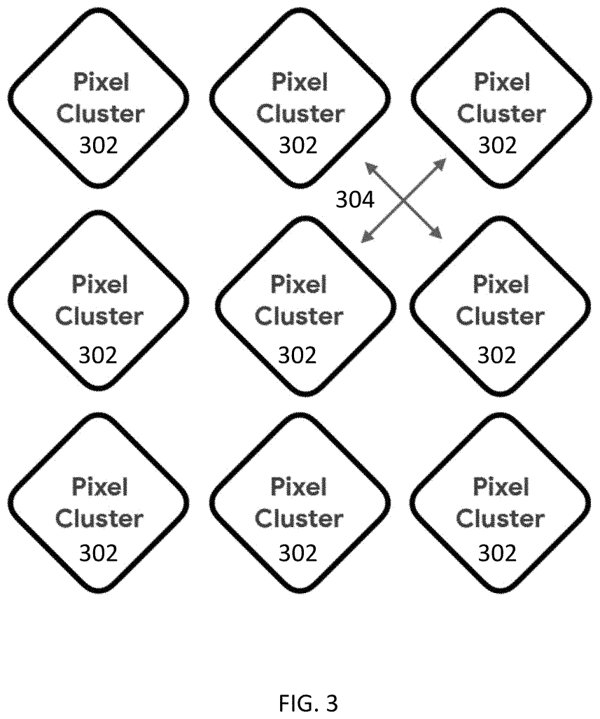

FIG. 2 illustrates an example organic light emitting diode (OLED) display 202 of a computing device 203 with four areas of differing pixel density—a first area 204, a second area 206, a third area 208, and a fourth area 210. Front-facing sensors 212 are located behind display 202 in first area 204. The pixels in each area 204, 206, 208 and 210 of the OLED display 202 are arranged in pixel-clusters such as those described below with reference to FIG. 3. A display driver module 220 (e.g., including a processor, such as a GPU, and/or other appropriate integrated circuit devices), housed within computing device 203, controls the operation of the display 202 by processing image data and generating appropriate drive signals for activating pixels in the display to present images.

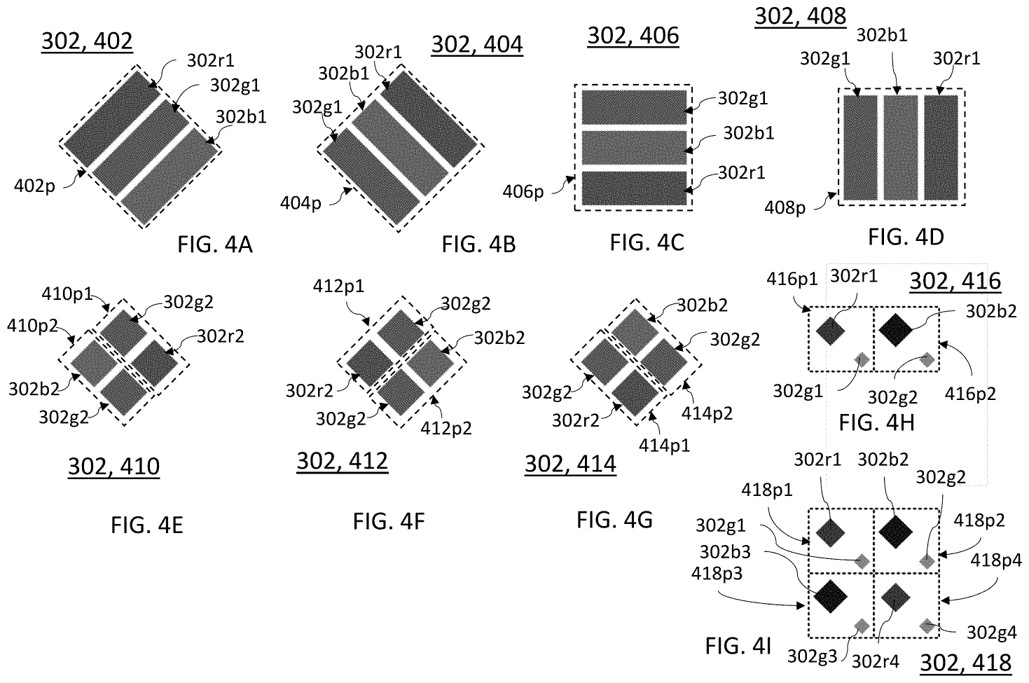

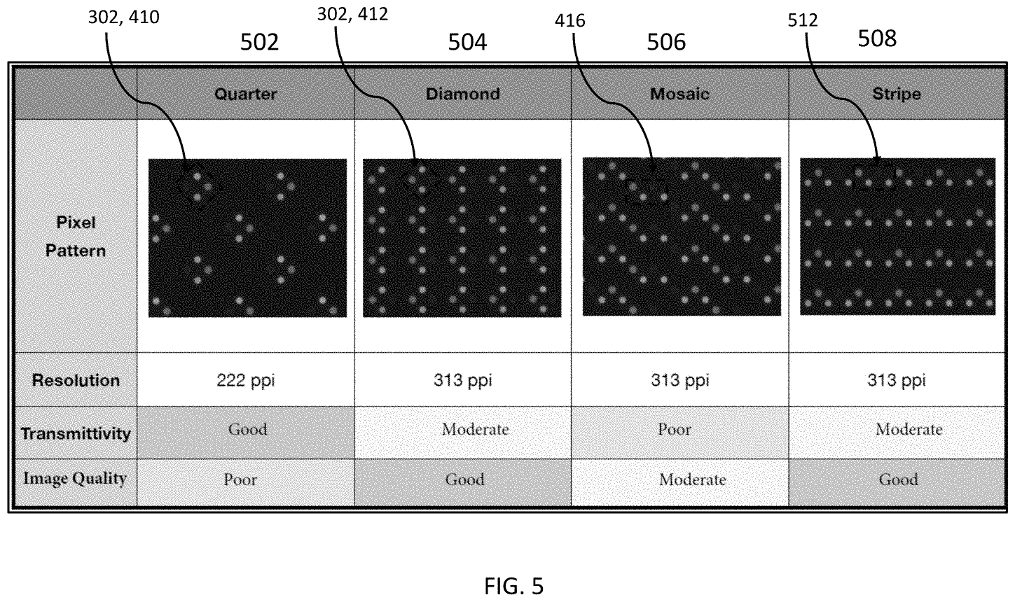

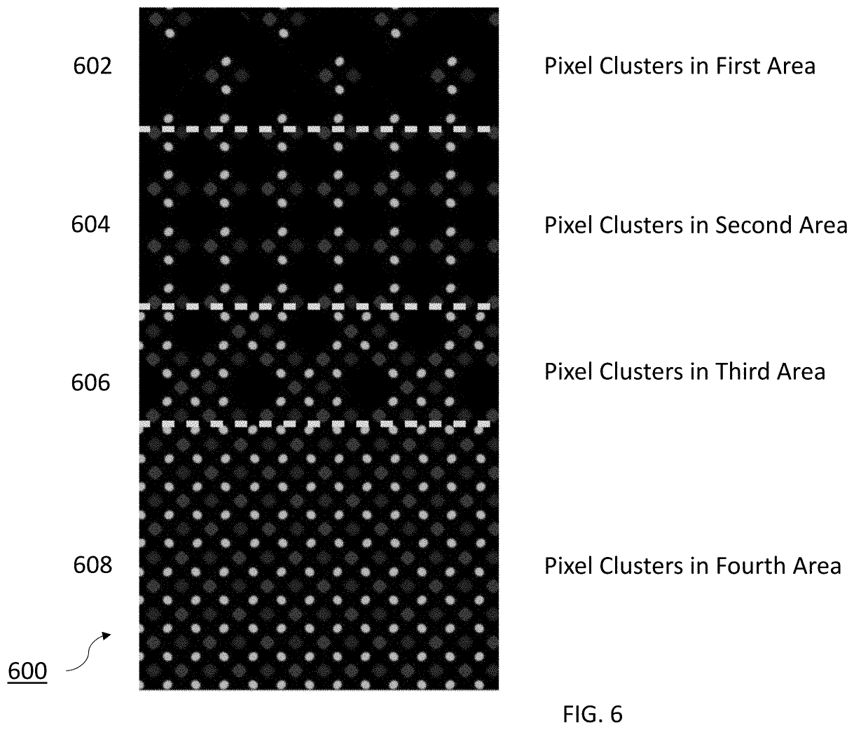

Generally, each pixel-cluster has one or more pixels, each of which can include two or more sub-pixels (e.g., three sub-pixels or four sub-pixels). Examples of pixel-clusters with corresponding pixels and sub-pixels are described below by FIGS. 4A-4I. The pixel-clusters can be arranged according to various patterns, depending on desired transmissivity and image quality, as explained below by FIG. 5. The resolution of the pixels (which can also be referred to as pixel-resolution or density of pixels) can gradually change (e.g., change in multiple small steps rather than one single step) from the first area 204 (which has the lowest resolution of pixels) to the fourth area 210 (which has the highest resolution of pixels), as described below by FIG. 6. This gradual resolution change can be implemented by a physical layout in a display panel, and/or by digital image content generated by software in the physically same resolution region each of the areas of the display.

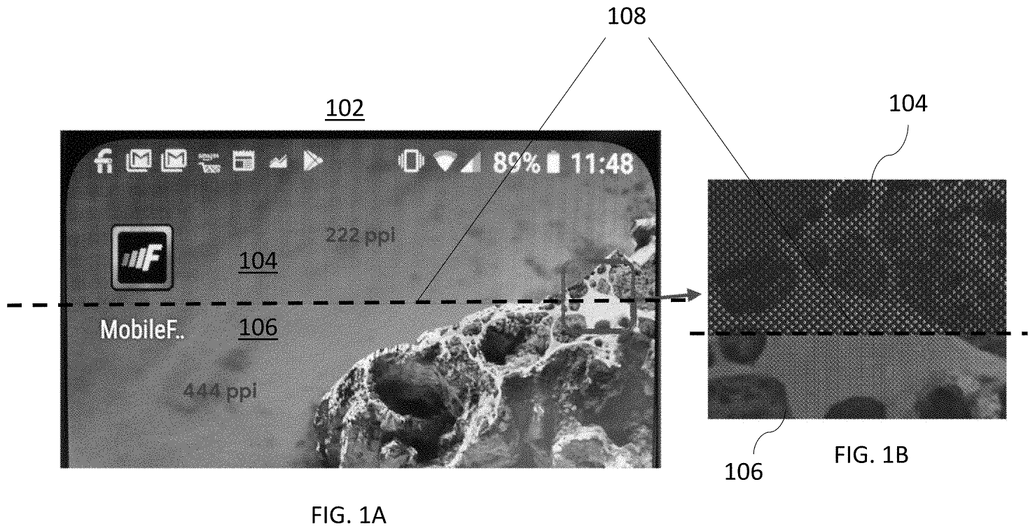

The presence of three or more areas (e.g., four areas as shown in FIG. 2) and the gradual change in resolution of pixels (as shown in FIG. 6) in those areas can reduce (e.g., obviate) the visual discontinuity perceived by a viewer where the image quality experiences a sharp discontinuity along the boundary of those two areas as described by FIG. 1.

Generally, pixel-resolution can be measured in pixels per inch and typically depends on the size of the display, its intended use (e.g., how far from the display the intended viewing distance is), and manufacturing constraints, for example. Displays with small form factors, such as those used in mobile devices intended for close viewing, can include areas with high pixel densities, such as greater than 300 pixels per inch (e.g., 400 pixels per inch or more, 500 pixels per inch or more) for example. The lowest pixel density of the display can be determined based on the transmittance of light through the low pixel density area needed for satisfactory operation of the front-facing sensors. In some embodiments, the lowest pixel density can be in the range of 200 pixels per inch or less (e.g., 180 pixels per inch or less, 150 pixels per inch or less, 120 pixels per inch or less, 100 pixels per inch or less, 80 pixels per inch or less).

In some examples, the pixel-resolution in the first area 204 can be between 125 pixels per inch and 175 pixels per inch, the pixel-resolution in the second area 206 can be between 200 pixels per inch and 250 pixels per inch, the pixel-resolution in the third area 208 can be between 275 pixels per inch and 375 pixels per inch, and the pixel-resolution in the fourth area 210 can be between 400 pixels per inch and 475 pixels per inch. In one specific example, the pixel-resolution in the first area 204 can be 157 pixels per inch, the pixel-resolution in the second area 206 can be 222 pixels per inch, the pixel-resolution in the third area 208 can be 313 pixels per inch, and the pixel-resolution in the fourth area 210 can be 444 pixels per inch. These pixel-resolution values are merely exemplary, and any other gradually changing values can be used for different areas.

Additionally, the number of areas with gradually changing pixel-resolutions is shown here as four, which is merely exemplary number. In other implementations, for example, there can be any number of areas with gradually changing pixel-resolutions, such as three, five, six, seven, eight, nine, ten, eleven, twelve, or so on.

Moreover, while a particular arrangement of differing pixel density areas is shown in FIG. 2, more generally, the size and location of these areas can vary as appropriate. Generally, the lowest pixel density area (i.e., area 204 in FIG. 2) is located over the front-facing sensors and should be sufficiently large to provide adequate light transmissivity of electromagnetic radiation through the display to and from the sensors. Accordingly, in some embodiments, the low pixel density area can be situated at an edge of the display, e.g., at the top edge. Typically, the low pixel density area occupies a small amount of the total area of the display (e.g., 10% or less, 5% or less, 2% or less).

Generally, the highest pixel density area (i.e., area 210 in FIG. 2) should occupy the majority of the display, providing the highest image quality and therefore best user experience. In some embodiments, the highest pixel density area can be 80% or more (e.g., 90% or more, 95% or more) of the total display area. Intermediate pixel density areas (i.e., areas 206 and 208 in FIG. 2) are generally arranged between the lowest pixel density area and the highest pixel density area. Typically, they are sufficiently large to provide a gradual transition in pixel density from the low pixel density area to the high pixel density area, as perceived by the user.

In general, the geometry of each pixel in different areas of the display can be the same or can be different. For example, the size and shape of the OLED for each same-colored sub-pixel in each of the areas (e.g., areas 204, 206, 208 and 210 in FIG. 2) can be the same or substantially similar. Identical sizes of such OLEDs in various areas means that with the gradual increase in pixel density (as measured in pixels per inch) between areas, there is a corresponding gradual decrease in space, per inch of display, between each pixel that does not emit light. Generally, area 204 that has the most amount of space between each OLED has the highest light transmissivity for passing through the OLED display. In contrast, area 210 that has the highest pixel density correspondingly has the least amount of space between OLEDs and therefore has the lowest light transmissivity through the OLED display 202.

However, the trade off for having a low pixel density in area 204 compared to area 210 is that the quality of a displayed image can be poorer in area 204 compared to area 210.

To ensure that the change in pixel-resolutions is gradual, a difference between pixel-resolutions of adjacent areas can have a corresponding upper threshold value. For example, the difference between a pixel-resolution of the second area 206 and a pixel-resolution of the first area 204 can be less than a first threshold value. A difference between a pixel-resolution of the third area 208 and a pixel-resolution of the second area 206 can be less than a second threshold value. A difference between a pixel-resolution of the fourth area 210 and a pixel-resolution of the third area 208 can be less than a third threshold value. In one example, the first threshold value can be 75 pixels per inch, the second threshold value can be 90 pixels per inch, and the third threshold value can be 135 pixels per inch. These values of thresholds are merely exemplary, and in alternate implementations each of the first threshold, the second threshold and the third threshold can have any other values.

Generally, the variation in pixel density between adjacent areas of different pixel density can vary depending on the maximum and minimum pixel densities of the display, and the visual impact of the variation from region to region (e.g., determined empirically). For example, the change in pixel density between adjacent areas can be in a range from about 20 pixels per inch to about 150 pixels per inch (e.g., about 30 pixels per inch or more, about 40 pixels per inch or more, about 50 pixels per inch or more, such as about 130 pixels per inch or less, 100 pixels per inch or less, 80 pixels per inch or less).

As noted above, the physical location and dimension (i.e., physical space) of low pixel density area 210 corresponds to the location and dimension of sensors 212 in the computing device 203.

The sensors can include an image sensor (e.g., a camera), a proximity sensor, an ambient light sensor, an accelerometer, a gyrometer, a magnetometer, a fingerprint sensor, a barometer, a Hall effect sensor, a facial recognition sensor, any other one or more sensors, and/or any combination thereof. At least one sensor 212 can include a transmitter 214 and a receiver 216.

The OLED display can be driven with an active matrix display scheme, and the OLED display can be referred to as an active matrix organic light emitting diode (AMOLED) display. The active matrix display scheme can be advantageous over a passive matrix display scheme in a passive matrix organic light emitting diode (PMOLED) display, as AMOLED displays can provide higher refresh rates than PMOLED displays, and consume significantly less power than PMOLED displays.

The computing device 203 can be a mobile device, such as a phone, a tablet computer, a phablet computer, a laptop computer, a wearable device such as a smartwatch, a digital camera, any other one or more mobile device, and/or the like. In alternate implementations, the device 100 can be any other computing device such as a desktop computer, a kiosk computer, a television, and/or any other one or more computing devices that are configured to output visual data.

In general, pixels in display 202 can be grouped together in clusters. FIG. 3, for example, illustrates pixel clusters 302, each of which includes one or more pixels of the OLED display 202. Each pixel can include two or more sub-pixels (e.g., red, green and blue sub-pixels). Examples of pixel clusters 302 with corresponding pixels and sub-pixels are further described with reference to FIGS. 4A-4I. In certain implementations, each area 204, 206, 208 and 210 of the OLED display 202 includes pixel clusters 302 that have the same number and arrangement of pixels. However, the spacing between neighboring pixel clusters, indicated by arrows 304, varies depending on the area of the display the pixel clusters are in. The varied spacing between pixel clusters results in different pixel densities within each area. In some embodiments, different areas of the display can have pixel clusters with different pixel arrangements.

In embodiments where the physical pixel density varies between different areas, the gaps between neighboring pixel clusters is set during fabrication of the display panel. In an additional or alternate implementation, the gaps can be varied in software using image processing. The pixel clusters 302 can be arranged according to a particular pattern based on desired transmissivity and image quality, as explained below with reference to FIG. 5.

FIGS. 4A-4I illustrates various example pixel arrangements 402, 404, 406, 408, 410, 412, 414, 416, and 418 for pixel clusters 302. Each of the pixel clusters 402, 404, 406 and 408 includes a single pixel composed of three sub-pixels having differing arrangements. In each case, the pixel cluster is square and the sub-pixels are rectangular. More specifically, the pixel cluster 402 includes a single pixel 402p, the pixel cluster 404 has a single pixel 404p, the pixel cluster 406 has a single pixel 406p, and the pixel cluster 410 has a single pixel 410p. Each of the pixels 402p, 404p, 406p and 408p includes three sub-pixels—a red sub-pixel 302r1, a green sub-pixel 302g1, and a blue sub-pixel 302b1. The edges of pixel clusters 402 and 404 are rotated 45 degrees with respect to the edges of the display, while the edges of pixel clusters 406 and 408 are parallel with the edges of the display.

Each of the pixel clusters 410, 412 and 414 includes two rectangular pixels, each with two square sub-pixels. Particularly, the pixel cluster 410 includes pixels 410p1 and 410p2, the pixel cluster 412 includes pixels 412p1 and 412p2, and the pixel cluster 414 includes pixels 414p1 and 414p2. Each of the pixels 410p1, 412p1 and 414p1 includes two sub-pixels 302r2 and 302g2. Each of the pixels 410p2, 412p2 and 414p2 includes two sub-pixels 302b2 and 302g2.

Pixel cluster 416 is a rectangular pixel cluster that includes two square pixels 416p1 and 416p2. Pixel 416p1 includes a red sub-pixel 302r1 and a green sub-pixel 302g1. Both sub-pixels are square and rotated 45 degrees with respect to the pixel square. Similarly, pixel 416p2 includes a blue sub-pixel 302b2 and a green sub-pixel 302g2, with similar orientations. The green sub-pixels are smaller in area than the red and blue sub-pixels.

Pixel cluster 418 is a square pixel cluster composed of four square pixels 418p1, 418p2, 418p3, and 418p4. Pixels 418p1 and 418p4 each include a red sub-pixel 302r1 and a green sub-pixel 302g1. Both sub-pixels are square and rotated 45 degrees with respect to the pixel square. Similarly, pixels 418p2 and 418p3 each include a blue sub-pixel 302b2 and a green sub-pixel 302g2, with similar orientations. The green sub-pixels are smaller in area than the red and blue sub-pixels.

While each pixel shown in FIGS. 4A-4I have either two or three sub-pixels, in alternate implementations pixels may have other numbers (e.g., four, five, six, seven, eight, nine, ten, eleven, twelve, or so on) of sub-pixels.

FIG. 5 is a table illustrating examples of various patterns of pixel cluster arrangements. Specifically, column 502 shows a quarter pixel pattern in which pixel clusters 410 occupy a quarter of the area of the display, in a regular array. In this example, the pixels have a density of 222 pixels per inch. Transmissivity in this area is good (relative to the other examples in the table), but image quality is poor.

Column 504 shows a diamond pixel pattern in which pixel clusters 412. Here, the clusters occupy 50% of the area. In this example, the pixel density is 313 pixels per inch, transmissivity of light through the area is moderate, while image quality provided by the display in this area is good.

Column 506 shows a mosaic pixel pattern composed of pixel clusters 416 with a pixel density of 313 pixels per inch. Transmissivity in this area is poor, and it provides moderate image quality.

Column 508 shows a stripe pixel pattern at 313 pixels per inch. Transmissivity of this area is moderate and image quality is good. For all of these examples, the pixel density values shown in the drawing are merely exemplary, and can be varied as desired.

FIG. 6 illustrates an example arrangement of pixel-clusters 302 in each of the first area 204, the second area 206, the third area 208 and the fourth area 210 of display 202. Note that FIG. 6 shows a portion 600 of the display panel 202 shown in FIG. 2. Area 602 corresponding to a portion of the first area 204 which has one or more sensors 212 underneath. Because of the sensors, electromagnetic radiation (e.g., light) needs to pass through the OLED display 202 to the sensors 212 for optimal (e.g., accurate) detection (e.g., sensing). Accordingly, a highly transmissive pixel pattern is preferred for this area. In this example, area 602 has a quarter pixel pattern is shown which has good light transmission compared to the other patterns illustrated in FIG. 5.

Area 608 corresponding to a portion of the fourth area 210 of display 202, which does not include sensors and corresponds to the largest area of the display. Here, it is important that image quality is highest and transmissivity is unimportant. Accordingly, in the present example, area 608 includes maximum pixel density in which the pixel clusters are packed as closely as possible.

To avoid or obviate the problem where the OLED display 202 has only two areas, which can render a sharp undesirable contrast in image quality along the boundary of those two areas as described by FIGS. 1A and 1B, area 604 (corresponding to a portion of area 204 in display 202) and area 606 (corresponding to a portion of area 206 in display 202) have pixel cluster patterns with intermediate pixel densities compared to areas 602 and area 608. In this example, area 604 includes a diamond pixel pattern and area 606 includes a mosaic pattern.

Because areas 206 and 208 are not adjacent to any front-facing sensors, the transmissivity of these areas is not important to the operation of the sensors. Accordingly, the reduced pixel density and corresponding pixel patterns can be implemented entirely in digitally. For example, image processing software in the device can program certain pixels in these regions to remain inactive (i.e., black), thereby effectively providing an area with reduced pixel density compared to the physical pixel density of the display in that area.

To attain perceptual uniformity in brightness and color among different areas 602, 604, 606 and 608, each of those panels can be calibrated relative to each other. For example, the lower the resolution of pixels, the more the current can be provided to those pixels so that the different pixel density areas have uniform brightness. The presence of three or more areas (e.g., four areas as shown in FIG. 2) with gradually changing pixel-resolutions (as shown in FIG. 6) can therefore avoid the problem of a sharp undesirable contrast in image quality along the boundary of two areas with significantly differing pixel-resolutions (as shown in FIGS. 1A and 1B).

Various implementations of the subject matter described herein (e.g., the computing device 203, the display 202, and/or any other component associated with such computing device 203 and/or the display 202) can be implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly or machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the display 202 can display data to a user. The sensors 212 can receive data from the one or more users and/or the ambient environment. The computing device 203 can thus operate based on user or other feedback, which can include sensory feedback, such as visual feedback, auditory feedback, tactile feedback, and any other feedback. To provide for interaction with the user, other devices can also be provided, such as a keyboard, a mouse, a trackball, a joystick, and/or any other device. The input from the user can be received in any form, such as acoustic input, speech input, tactile input, or any other input.

Although various implementations have been described above in detail, other modifications can be possible. For example, the logic flows described herein may not require the particular sequential order described to achieve desirable results. Other implementations are within the scope of the following claims.

1. An apparatus comprising:
an organic light emitting diode (OLED) display comprising a first area having a first pixel density, a second area having a second pixel density, and a third area having a third pixel density, where the second area is arranged between the first area and the third area and the first pixel density is lower than the second pixel density, and the second pixel density is lower than the third pixel density; and
a sensor arranged behind the OLED display and positioned to detect electromagnetic radiation transmitted by the OLED display through only the first area of the OLED display,
wherein each of the first, second, and third areas comprise a plurality of pixels, each pixel of the plurality of pixels comprising one or more first sub-pixels for emitting light of a first color,
wherein each pixel in the first, second and third areas has the same size and shape and the first sub-pixels of the first, second, and third areas each have the same size and shape.

2. The apparatus of claim 1, wherein the OLED display further comprises a fourth area between the second area and the third area, the fourth area having a pixel density between the second pixel density and the third pixel density.

3. The apparatus of claim 1, further comprising a display driver module programmed to display images in the second area at the second pixel density lower than a physical pixel density in the second area.

4. The apparatus of claim 3, wherein the physical pixel density in the second area and a physical pixel density in the third area are the same.

5. The apparatus of claim 3, wherein the physical pixel density in the third area and the third pixel density are the same.

6. The apparatus of claim 1, wherein pixels in the first area are arranged in pixel clusters in a first pattern and pixels in the second area are arranged in pixel clusters in a second pattern different from the first pattern.

7. The apparatus of claim 6, wherein the first pattern is a quarter pattern.

8. The apparatus of claim 6, wherein the second pattern is a diamond pattern or a mosaic pattern.

9. The apparatus of claim 1, wherein the second area surrounds the first area.

10. The apparatus of claim 9, wherein the third area surrounds the second area.

11. The apparatus of claim 1, wherein the first area is located at an edge of the display.

12. The apparatus of claim 1, wherein the first area is 10% or less of a total area of the OLED display.

13. The apparatus of claim 1, wherein the third area is 80% or more of a total area of the OLED display.

14. The apparatus of claim 1, wherein the first pixel density is 250 pixels per inch or less.

15. The apparatus of claim 1, wherein the third pixel density is 400 pixels per inch or more.

16. The apparatus of claim 1, wherein the sensor is a camera.

17. The apparatus of claim 1, wherein the apparatus is a smartphone.
